(19) United States
(12) Patent Application Publication
(10) Pub. No.: US 2007/0291003 A1
(43) Pub. Date: Dec. 20, 2007

(54) LAP POSITIONED COMPUTER CURSOR CONTROL /INPUT DEVICE

(75) Inventors: Joe J. Fanelli, Phoenix, AZ (US); Jay M. Fanelli, Lafayette, CA (US)

Correspondence Address: FOLEY & LARDNER LLP, 1530 PAGE MILL ROAD, PALO ALTO, CA, 94304, US

(73) Assignee: The Hesed Consortia, LLC

(21) Appl. No.: 11/614,911

(22) Filed: Dec. 21, 2006

Related U.S. Application Data
(60) Provisional application No. 60/813,906, filed on Jun. 14, 2006.

(51) Int. Cl. G06F 3/033

(52) U.S. Cl. 345/167; 345/157

(57) ABSTRACT

A computer cursor control which includes a base having two side ends, a bottom surface and a top surface is disclosed. The bottom surface of the base has a concave side-to-side cross section. This concave cross section is ergonomically shaped to conform to and engagingly rest upon the thigh of a user in a variety of sitting positions with the two side ends extending downward below the top of the thigh-engaging contour. The top surface carries a palmer dome upon which the user's hand rests in its most natural condition and the cursor control and other controls are positioned around and upon surfaces of the palmer dome in locations which enable the most used controls to be accessed by the most dexterous digits.

### CROSS-REFERENCE TO RELATED PATENT APPLICATIONS

This application claims priority to U.S. Provisional Application Ser. No. 60/813,906, filed Jun. 14, 2006, incorporated herein by reference in its entirety.

### FIELD OF THE INVENTION

This invention relates to a computer cursor control/input device. More particularly it concerns such a device that is ergonomically adroit.

### BACKGROUND OF THE INVENTION

The use of computers, whether they be configured as personal computers or as electronic games or as personal assistance devices, all involve inputting information. This is most commonly carried out by inputting information with a keyboard. It is also commonly carried out by positioning a movable cursor such as with keyboard keys, a computer “mouse”, a joystick, a track pad or a track ball. These types of cursor-positioning input devices rely upon the user's physical dexterity to manipulate the cursor into various positions. It has been well recognized that repetitive use of conventional input devices can lead to fatigue and even to injury to the user. Carpal tunnel syndrome (“CTS”), cumulative trauma disorder (“CTD”) and repetitive stress syndrome (“RSS”) are just three conditions attributed to the use of computer input equipment.

A number of devices addressing these problems have been described heretofore. For example, U.S. Pat. No. 5,029,260 points out that there are ergonomic advantages to having a keyboard which can be positioned on the user's lap, as opposed to being located on a desk top. It discloses a keyboard suitable for locating on the user's lap which has a lower surface which is recessed to allow the keyboard to conform to the user's thighs and having a top (keyboard) surface that is curved outward toward the user. U.S. Pat. No. 6,290,228 shows a computer game that can be located in the user's lap. This game has side extensions which can be positioned to press in upon the user's legs to help hold the game in position on the user's lap. U.S. Pat. Nos. 6,353,530 and 6,529,369 show laptop computer keyboards having concave depressions in their lower surfaces to engage their user's lap. U.S. Pat. No. 5,644,338 describes how positioning a computer or a computer keyboard on the operator's lap can relieve overuse stress and injury and provides a divided keyboard which positions the keys in two groups across the user's lap. However, this patent does not appear to contain disclosure concerning features to make its keyboards more lap-compatible.

U.S. Pat. No. 6,806,865 and related published United States Patent Application Serial Number 2002/0105503 each concern an integrated joy pad for a handheld personal digital assistant (“PDA”) or handheld computing device. Such devices have a number of input functionalities including an attachable writing stylus/joystick, various keys, a joy pad and a touch screen. Lap compatibility is not stressed in this patent and application.

U.S. Pat. No. 6,288,709 concerns a computer input device which the user grasps in both hands so as to actuate switches on its top and bottom surfaces with the fingers and thumbs.

U.S. Pat. Nos. 5,426,449 and 6,381,128 describe ergonomic improvements to computers and computer keyboards but describe these improvements in the context of desktop-positioned units.

### STATEMENT OF THE INVENTION

An improved computer input device has now been discovered. This device is characterized as being more ergonomically adroit than similar devices described in the art and thus usable with less fatigue and reduced likelihood of injury to the user.

This device is further characterized as facilitating a neutral position of its user's shoulder as well as the user's entire upper arm through wrist, hand and fingers when in use.

This invention provides a computer cursor control/input device which includes a base having a front, a back, two side ends, a bottom surface and an upper surface. This device is ergonomically adroit. It has a “palmer dome” located on and extending upwards from the upper surface of the device with the “dome” being of a size and shape which ergonomically fits the palm of the user. The device's input functionalities are placed relative to the dome so that the most commonly-used controls, such as a cursor control and “right click” control are located in positions to be manipulated by the user's most dexterous digit (the index finger.) A portion of the input functionalities are located on the side of the dome to position them adjacent to the second most dexterous digit (the thumb) of the user. This placement of certain functions near the thumb and index finger of the user leads to the input device being “handed”, that is being adapted to conform to either the right or left hand of the user but typically not to both.

One or more cursor control and data input functionalities are mounted on the upper and side surfaces of the base in locations corresponding to the locations of the user's fingers when the user's hand is resting on the device with the more commonly-used input functionalities located adjacent to the most dexterous fingers, the thumb and index fingers. The bottom surface of the base has a concave side-to-side cross-section. This concave cross-section is ergonomically shaped to conform to and engagingly rest upon the thigh of a user in a variety of sitting positions with the two side ends extending downward below the top of the thigh-engaging contour. Both of the two side ends can be weighted to supply position-stabilizing mass to the device when it is in use. Similarly, the input device can include extendable springy side grips which, when extended, can position the device to the user's thigh and cause it to grip the thigh.

The device additionally may include a layer of nonslip material such as the nonslip flexible plastic material marketed by Dycem Limited affixed to the concave lower surface to further stabilize the support on the user's thigh in various straight-leg and crossed-leg sitting positions. By permitting placement in a variety of sitting positions, it is possible for the user to assume a variety of natural neutral positions and move from one position to another which will assure less fatigue and reduced likelihood of repetitive-use-induced injury to the user.

The input device is connected to a computer either by hard wire or, more commonly, by wireless connection. In the case of a wireless connection, the stabilizing masses in the ends of the device may conveniently be the batteries powering the device.

The input device may be provided in a variety of sizes to accommodate various body types. It may also be adjustable with downward-extending side ends moving inwardly and outwardly, relative to one another, to fit smaller and larger users respectively.

The entire input device in its various embodiments can be sewn into, attached, or by various means wholly contained within a fabric sleeve suitable for fastening around the user's thigh. This fabric sleeve can be made from ballistic nylon, stretch fabric or similar material and extends from either side of the device and wraps around the user's thigh and fastens to itself by means of Velcro® strips or tabs or buckles.

It will be readily appreciated by those of skill in the art that the advantages of this input device will be realized in a wide range of computer and game settings and that the controls of this device can be configured to interface with MS/DOS, UNIX and Apple® operating systems.

### BRIEF DESCRIPTION OF THE DRAWINGS

This invention will be further described with reference being made to the accompanying drawings. When appropriate, the same reference number is used to refer to the same part appearing in multiple drawings. In these drawings

FIG. 1 is a front elevational view of the input device of this invention.

FIG. 2 is a side elevational view of the input device of this invention.

FIG. 3 is a top plan view of the input device of this invention.

FIG. 4 is a front elevational view of a second embodiment of the input device of this invention having the capability of being adjusted to fit a variety of size of users.

FIGS. 5 and 6 are partially cut away front and side elevational views of the device of the invention showing the possibility of placing weights such as batteries low on the sides of the device to assist in stabilizing the device on the user's thigh.

FIG. 7 is a partially phantom view of the underside of the device of this invention showing an alternative location for the batteries.

FIGS. 8 and 9 are front and side elevational views of another embodiment of the device of the invention having extendable side grips which can be extended out of the body of the device and fit around and affix the device to the user's thigh.

FIGS. 10 and 11 are front and side elevational views of another embodiment of the device of the invention having a track ball as its cursor control.

FIG. 12 is a perspective sketch showing the input device of this invention in use on a user's thigh.

FIGS. 13 and 14 show a variation of the device mounted within a ballistic nylon or similar cloth wrap which can be affixed around the thigh of the user by means of Velcro® strips or tabs.

### DETAILED DESCRIPTION OF THE EMBODIMENTS

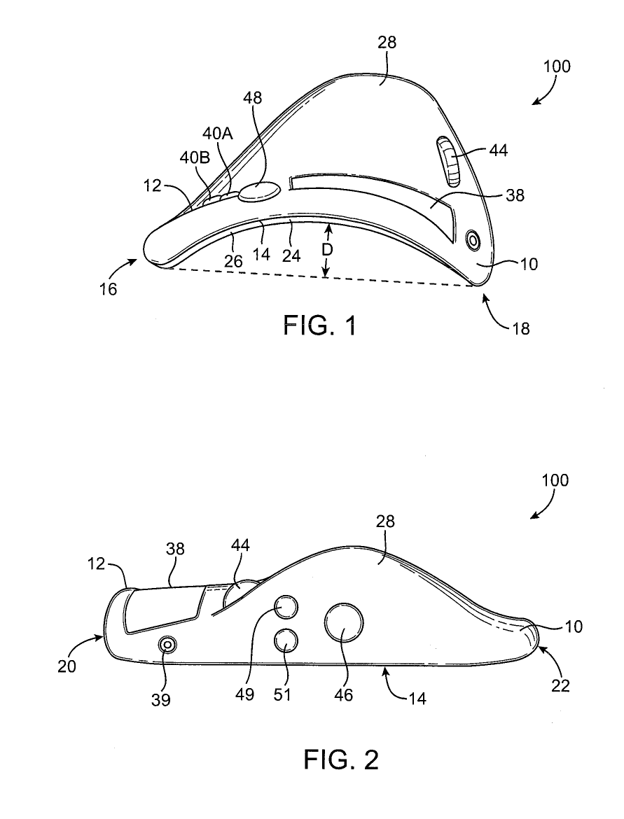

Turning first to FIGS. 1, 2, and 3, an embodiment 100 of the computer cursor control/input device is shown. Device 100 includes a base 10 having an upper surface 12 and a bottom surface 14. Device 100 has opposed sides 16 and 18 and a front 20 and a rear 22. Bottom surface 14 is concave in side-to side section, when viewed from the front 20 or the rear 22. That is, its center 24 is higher by a distance “D” than edges 16 and 18. This concave shape extends along the entire length of support 10 from its front 20 to its rear 22 and generally approximates a section of a cylinder. This concave shape mates with (or corresponds to) the curvature of he user's thigh such that the base can rest securely there. This is commonly accomplished when “D” is in the range of from about ¼ inch to about 1 inch.

A nonslip surface 26 is usually present on bottom surface 14. This nonslip surface can be of any material which facilitates the stable placement of the device 100 on the user's thigh. Such materials can include, for example, a rough pattern molded into surface 14, a layer of fabric, a smooth consistent thickness layer of foam such as foam rubber, a layer of natural or synthetic suede, or the like. This layer typically covers essentially all of surface 14. The nonslip sheet goods manufactured and marketed by Dycem Limited of Bristol, England under the trademark “Dycem” is a preferred nonslip surface. It can be affixed to the underside of the device with contact cement or the like.

The upper surface of device 100 includes computer cursor control 38 as well as other computer controls. The upper surface presents an ergonomically shaped “dome” 28 which is a “palmer dome”, that is a dome sized and shaped to fit into the user's palm when the user's hand is placed upon it, palm down. This dome, viewed from above is generally conical in shape tapering downward toward the ulnar side (little finger side) and being more pronounced on the radial side (thumb and index finger side).

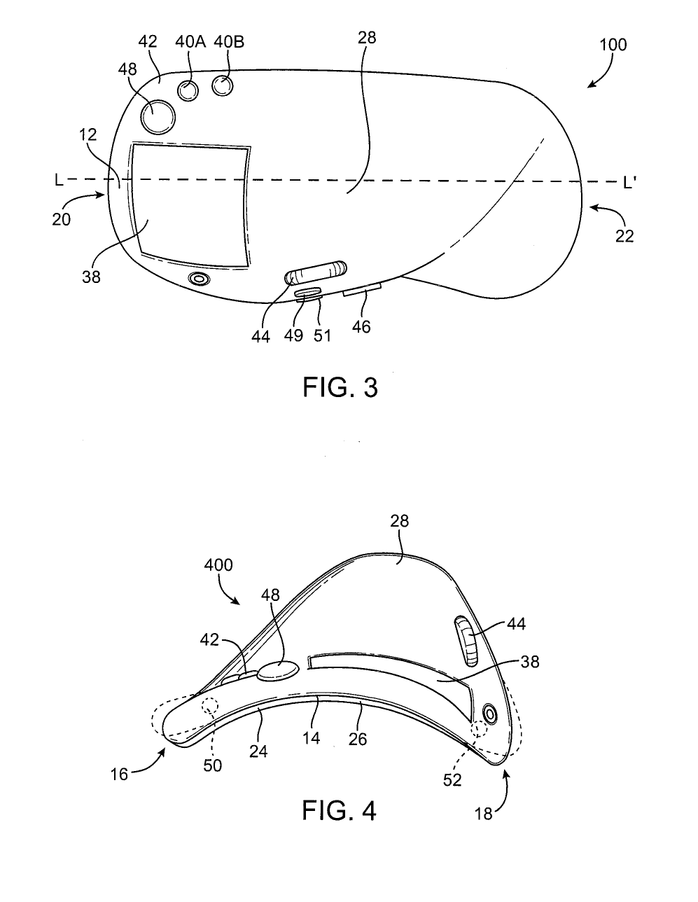

The overall design of the dome 28 and the surface 12 upon which it is located exploits the biometric shape of the human hand. It facilitates the location of each of the fingers and the curve of the hand when the hand and fingers are in their most relaxed “open palm spread” position. The dome 28 provides a “rest” area for the user's palm and each of the digits which provide inert placement of the hand when it is not manipulating the various controls on the device. The long axis of device 100 and the palmer arch dome 28 (L-L′ in FIG. 3) runs down the user's middle finger when the hand is at rest and thus the long axis of the hand and the long axis of the device are congruent when the hand is at rest. The dome 28 is shaped to slope downward from the middle finger toward the ring and little fingers and to slope upwardly slightly from the L-L′ axis and to then descend almost vertically between the thumb and the index finger when the user's hand is resting upon it.

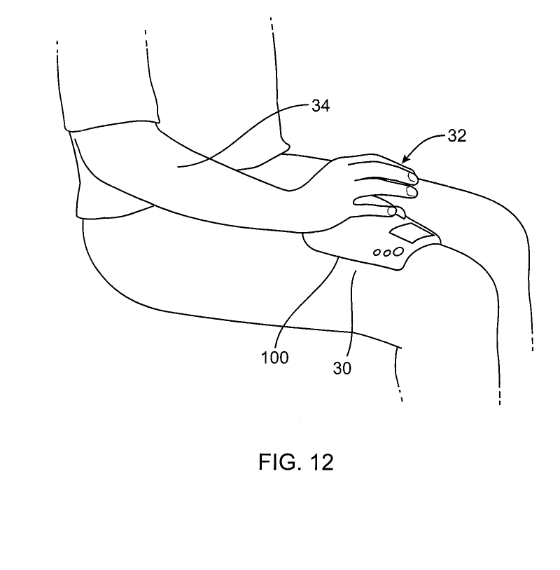

As shown in FIGS. 12 and 14, one of the advantages of this device is that when placed on the user's thigh 30, device 100 can be positioned so as to be directly under the user's hand 32 when the user's arm 34 is in its most natural and most relaxed position. It will be appreciated that in FIGS. 12 and 14, the user's wrist is bent back to show the device 100 or 1200 located beneath the user's hand 32 and that in use, the hand 32 would be set down upon the device with its fingers able to manipulate the controls on the upper surface in their most natural neutral position without undue movement or repositioning of the user's hand during use.

It will also be appreciated that this upper surface 12 with dome 28 and the layout of the controls upon it is typically “handed”. That is it is configured to fit either a right or a left hand so as to take advantage of the user's preferences for using one's thumb and forefinger for the more commonly called for commands and the middle finger, ring finger and little finger for the less commonly accessed commands.

The computer controls on the upper surface 12 include a computer cursor control 38. In device 100, this control is depicted as a track pad 38. When the user's fingers move across the track pad 38, a cursor control signal is generated which is sent to the computer via a wireless (“Bluetooth”) connection or by a “hard wire” connection such as through plug 39. Control 38 is located on the left front end of dome 28 so that, in use, the right-handed user's right index finger falls readily upon it when the user's arm, wrist and fingers are in their most natural position.

Control device 100 generally, but not necessarily, contains additional controls, all of which may be wireless or hardwired just as with control 38. These include one or more (two are shown but one to five are typical) application launch touch buttons 40 (shown as 40A and 40B). These controls can be preprogrammed or custom programmed to actuate one or more specific computer functions. These can be mechanical switches, capacitance switches and the like. These controls are located on the relatively horizontal apron portion 42 of the top surface in front of or alongside the domed area 28. These launch controls are generally less commonly used than certain other controls so it is appropriate to locate them in positions where they can be actuated by the user's middle, ring or little fingers, rather than by the more dexterous index finger and thumb. These launch controls should be in a position that is not so close as to lead to inadvertent touching and unwanted launchings of the various applications. Any and all of these controls can be preprogrammed or programmed by the user in real time.

Device 100 can also include a scroll wheel 44 positioned on the top surface 12 in a location where it can me manipulated by the index finger. This scroll wheel can be a conventional two direction scroll wheel or it can be a multi-axis scroll wheel not only capable of scrolling forward and backwards but also side to side.

Device 100 can include one (or more commonly two) mouse control buttons 46 and 48. In a PC or MS/DOS environment, buttons 46 and 48 can correspond to the “left click” and “right click” buttons respectively on a conventional Microsoft® operating system control and can be programmed accordingly. Left click control 46 is placed on the left side of the dome where it can be easily accessed by the user's thumb. Right click control 48 is located on the more horizontal apron 42 of the top surface 12 immediately to the right of the touch pad 38 where it can be easily accessed by the user's index and middle fingers. Again, these locations are selected so that the right click function control is easily accessed by the user's index finger since the right click is the most commonly used “click” function and the user's index finger has the greatest dexterity. Similarly, the left click is the second most used “click” function and it is positioned for activation by the thumb, the second most dexterous digit. These controls are readily reached by the user's thumb and fingers respectively but not likely to be inadvertently accessed.

In another embodiment, when device 100 is being employed in an Apple® operating system environment, the two buttons 46 and 48 can be replaced by a single button or control which is programmed to convey the “click” commands within that environment. In an “Apple”® type environment it may be desirable to eliminate some or all of the launch buttons 40A, etc as well as the scrolling control 44 and to program the functions of these controls into the track pad 38 or its equivalents as will be hereinafter described and as is commonly done with peripheral devices used within an Apple® operating environment.

Additionally, the device 100 can include an “up” and a “down” control for cursor movement or scrolling. These are exemplified as up button 49 and down button 51 located on the side of the device 100 alongside the dome where they can be facilely manipulated by the user's thumb.

Device 100 is but one representative embodiment of the controller of this invention. FIG. 4. shows another embodiment 400. Embodiment 400 is similar to device 100 as shown by a number of corresponding functions and features. Embodiment 400 adds the feature that it can be adjusted to change the shape of the cylindrical section of concave bottom surface 14 to conform to the thigh shapes of larger and smaller users. Embodiment 400 includes a pair of hinges 50 and 52 having axes parallel to the axis of the cylindrical section. This permits the sides 16 and 18 to bend inward (as shown in solid line) or outward (as shown in dashed line). In addition to adapting the device to fit different size users, these hinges can work to hold the device in place on the user's thigh by means of spring loading or by means of resistance built into the hinges to hold the device in a configuration that will grip the user's thigh to some extent.

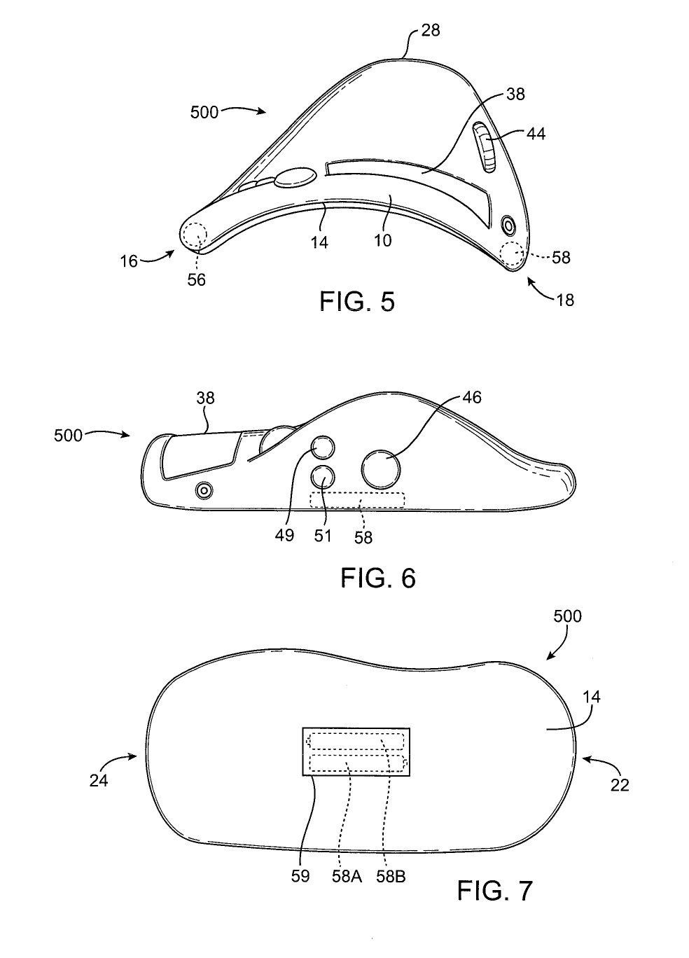

Turning to FIGS. 5 and 6 another embodiment 500 is shown. This embodiment includes a pair of weights 56 and 58 located in the outer lower side edges 16 and 18 of body 10. These weights, are located low, relative to the top of the curvature of concave lower surface 14. Batteries are typical weights which can be so placed. These weights provide a stabilizing effect and hold the device in place on the user's thigh.

Alternatively, the weights in the form of batteries 58A and 58B can be positioned under the dome 28 of device 500 where they can be accessed by removing cover 59.

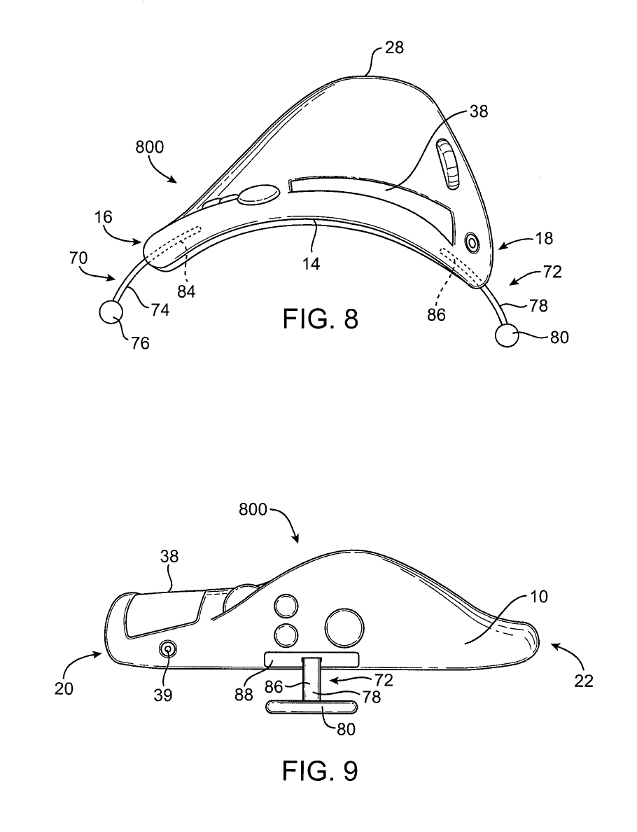

Embodiment 800, depicted in FIGS. 8 and 9, provides yet an additional structure for holding the device of the invention in place on the user's thigh. Device 800 is similar to device 100 and device 400 but includes a pair of retractable extendable side flaps or grips 70 and 72. These grips 70 and 72 are shown in their extended positions in FIGS. 8 and 9. Grip 70 includes a curved resilient arm 74 made of spring steel, titanium, hard molded ABS plastic, or the like which, when extended, runs from body 10 to gripper 76. Grip 72 includes corresponding arm 78 and gripper 80. Arms 74 and 78 have a built-in curvature which, in combination with the resiliency of the arms, causes the grips to be biased inward toward the user's thigh. This springy biasing provided by arms 74 and 80 provides additional gripping and stabilization of the device 800 on the user's thigh much in the way a hair band grips the head of a user. The extendable side grips 70 and 72 can be retracted into device 800 when not in use. Arm 74 can be retracted into channel 84 and arm 80 can be retracted into channel 86. Although not a requirement, in device 800, grippers 76 and 80 are shaped to conform in contour to the body 10 of device 800 when they are retracted. To that end, as shown in FIG. 9, body 10 includes a recess 88 into which gripper 80 can fit when side grip 72 is retracted. A corresponding recess is provided on the reverse side of device 800, as well. to accommodate side grip 70 when it is retracted.

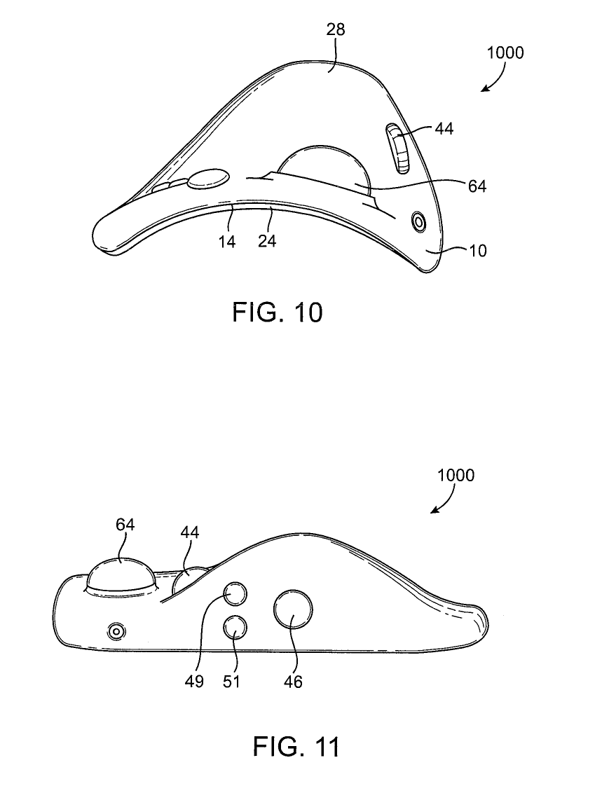

Device 100 employs a touch pad cursor control. This is merely representative. Other cursor controls can be used, including joy sticks and the like. As shown in FIGS. 10 and 11, which illustrate device 1000, a track ball 64 can be used in place of the track pad 28. This track ball 64 is located on the front end of the device 1000 immediately in front of the dome 28 so as to fall conveniently to hand for easy operation by the user's index finger. The other features described with reference to devices 100, 400, 500 and 800 can, of course, be present in device 1000, if desired.

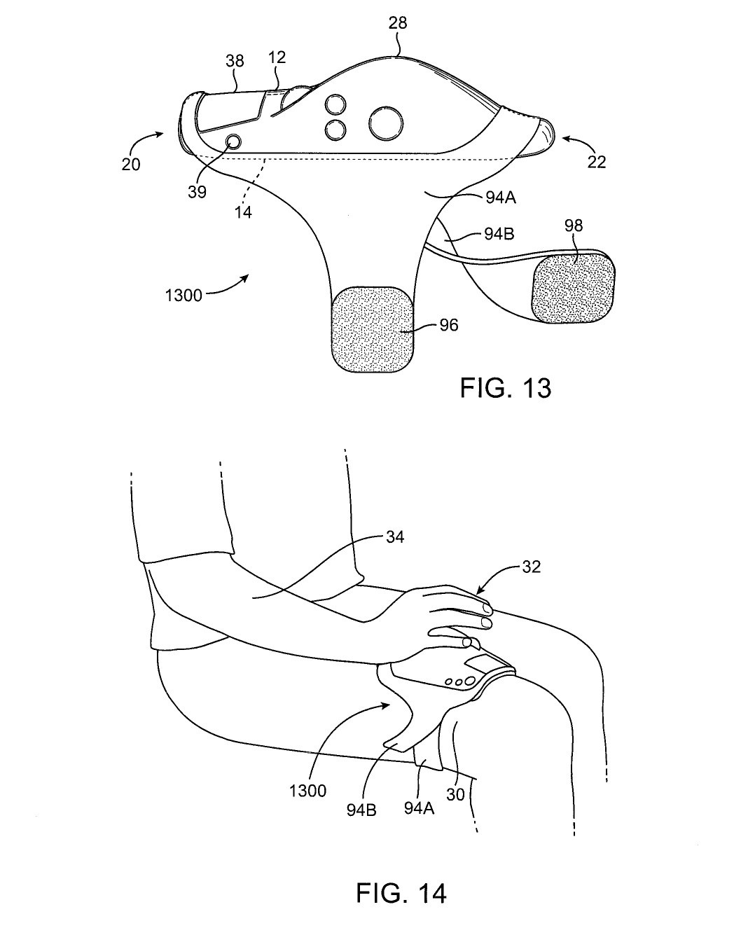

Embodiment 1300 depicted in FIG. 13 provides yet an additional structure for holding the device and its variations to the thigh of the user. Device 1200 is similar to device 100 and 400 but it is built into a ballistic nylon, stretch nylon or similar cloth wrap 92 that is affixed to the user's thigh by wrapping straps 94A and 94B around the thigh 30 and attaching them together by means of Velcro® strips or tabs 96 and 98. Any other devices, for affixing straps 94A and 94B to one another can be used as well such as adjustable buckles, snaps, clasps or clips which are easily integrated into the strapping material. This variation, can be employed alone or together with the variations of FIGS. 1 through 11.

FIGS. 12 and 14 illustrate embodiments 100 or 1300 of the device of this invention in use on the thigh of a user. In FIG. 12 the device rests on the thigh 30 and is held in place by the shape of the lower surface 14 and by the anti-slip coating 26. In the case shown in FIG. 14 straps 94A and 94B are affixed together to assist in holding the device in place.

While this invention has been described with reference to certain preferred embodiments, it is to be understood that these embodiments are not to be construed as limiting the scope of this invention or the scope of protection afforded by this patent which are both defined by the following claims.

What is claimed is:

1. An ergonomically adroit computer input device comprising a cursor control that controls the movement of a computer cursor on a computer display screen for use by a sitting user while resting on the user's thigh including a thigh support having a thigh-conforming concave lower surface to stabilize the device on the user's thigh.

2. The computer input device of claim 1 wherein the device has a front and a rear, an upper surface, a concave lower surface and first and second sides, the lower surface and sides defining the support by the lower surface having a generally cylindrical section contour with its axis running from the front to rear of the device said contour conforming to the top surface curve of the user's thigh and the first and second sides each having an extension extending downward on an opposing side of the user's thigh to below the top surface of the user's thigh, and wherein the upper surface comprises a base with an upwardly extending palmer dome running from front to back and sized and shaped to conform to and engage the palm of a user's hand and wherein the cursor control is positioned at the front end of the palmer dome so that it can be manipulated by the user's index finger while the user's palm is resting on the palmer dome

3. The computer input device of claim 2 additionally comprising a layer of nonslip material present upon the concave lower surface to stabilize the support on the user's thigh.

4. The computer input device of claim 3 wherein the first and second sides of the base each pivot on pivot axes parallel to the axis of the cylindrical section to adapt the shape of the concave surface to the size of the user's thigh.

5. The computer input device of claim 3 additionally comprising a fabric housing which surrounds and engages the device and provides at least one strap which fastens around the user's thigh when the device is setting upon the user's thigh.

6. The computer input device of claim 3 additionally comprising weights located in each of the extensions of the first and second sides, these weights supplying position-stabilizing mass to the support at positions below the top surface of the user's thigh.

7. The computer input device of claim 3 additionally comprising battery packs for powering the input device located in each of the extensions of the first and second sides, these battery packs supplying position-stabilizing mass to the support at positions below the top surface of the user's thigh.

8. The computer input device of claim 3 additionally comprising a pair of extendable/retractable grippers, one located in each of the extensions of the fist and second sides of the support, these grippers, in their extended position supplying an inward-pressing position-stabilizing grip on the user's thigh at positions below the top surface of the user's thigh.

9. The computer input device of claim 8 wherein the outer ends of the grippers are shaped to conform to the shape of the outer edge of the side of the support such that when the extensions are retracted the outer ends and the outer edge present a uniform smooth shape.

10. The computer input device of claim 3 wherein the cursor control is selected from a track pad, a track ball and a joy stick.

11. The computer input device of claim 3 additionally comprising at least one application launch control located on the top surface of the base in front of the dome in a position that can be accessed by the user's ring finger and little finger.

12. The computer input device of claim 3 additionally comprising a right click and left click control, the right click control located on the top surface of the base in front of the dome beside the cursor control so that it can be accessed by the user's index finger and middle finger and wherein the left click control is located on the side of the dome so that it can be accessed by the user's thumb.

13. The computer input device of claim 3 additionally comprising a scroll wheel located on the top surface of the base in front of the dome beside the cursor control so that it can be accessed by the user's index finger and middle finger.

14. The computer input device of claim 3 additionally comprising up and down controls located on the side of the dome so that they can be accessed by the user's thumb.

15. The computer input device of claim 3 additionally comprising a wireless connection to the computer.
